(19) United States
(12) Patent Application Publication
(10) Pub. No.: US 2006/0159047 A1
(43) Pub. Date: Jul. 20, 2006

(54) Method and system for context transfer across heterogeneous networks

(75) Inventors: Ulises Olvera-Hernandez, Kirkland (CA); Alan Gerald Carlton, Mineola, NY (US); Guang Lu, Montreal (CA); Juan Carlos Zuniga, Montreal (CA); Maged Zaki, Pierrefonds (CA); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/263,011

(22) Filed: Oct. 31, 2005

Related U.S. Application Data
(60) Provisional application No. 60/645,469, filed on Jan. 18, 2005.

(51) Int. Cl. H04Q 7/00

(52) U.S. Cl. 370/331

(57) ABSTRACT

A method and apparatus for triggering procedures to handover an ongoing communication session between a mobile station (MS) and a correspondent node (CoN) from via a first network of a first type to via a second network of a different type. Communication session continuity is maintained by transferring communication session context information when a handover is imminent from a network component in a first network path to a network component in a second network path, and by forwarding downlink and uplink signals via the network components in both the first and second network paths until the ongoing communication session can be established via the second network path. The context information includes the session communication parameters, such that the second network path can allocate resources and establish routing between the MS and the CoN.

### CROSS REFERENCE TO RELATED APPLICATION

This application claims the benefit of U.S. Provisional Application No. 60/645,469 filed Jan. 18, 2005, which is incorporated by reference as if fully set forth.

### FIELD OF INVENTION

The invention relates to the area of wireless communications. Specifically, the invention relates to the transfer of communication session context information to facilitate handover of the communication session between heterogeneous network types, such as between any of various cellular network types, wireless IEEE 802 compliant network types, and wired IEEE 802 compliant network types.

### BACKGROUND

Wired and wireless communication systems are well known in the art. In recent years, widespread deployment of different types of networks has resulted in locations at which access to more than one type of network is available. Communication devices have been developed which integrate two or more different network access technologies into a single communication device. For example, there exist communication devices having the ability to communicate via more than one type of wired and/or wireless standards, such as IEEE 802 compliant wired local area network (LAN) and wireless local area network (WLAN) standards, and cellular technologies such as Code Division Multiple Access (CDMA), Global System for Mobile communications (GSM), and General Packet Radio System (GPRS) standards. Communication via each standard is referred to as a communication mode, and devices which can communicate via more than one communication standard are called multi-mode devices.

Existing systems that support integration of two or more network access technologies into one device do not generally provide inter-working between the different access technologies. In other words, a communication device that supports multi-mode functions does not, without more, provide inter-working between the different access technologies necessary to enable it to perform handover of an ongoing communication session between the different access technologies. Thus, there is a need for devices that enable full handover-type functionality from one type of network to another without interrupting an ongoing communication session. For example, a user should be able to start a communication session which would benefit from a high data rate, such as a video call, on a cellular network, but if a WLAN hotspot with greater capacity becomes available, such as by the user entering its service area, the video call should be able to switch over to the WLAN. If during the call the WLAN subsequently becomes unavailable, such as by the user leaving its service area, the session should be able to switch back to the cellular network.

The present invention addresses the need for signaling conventions, protocols and signaling methods which determine how relevant context information can be transferred between heterogeneous communication systems, to facilitate handover of an ongoing communication session from a first network to a second network of a different type.

### SUMMARY

A method and apparatus are presented for facilitating mobility handling of a multi-mode communications device across different communication technologies, by transferring across heterogeneous networks context information regarding an ongoing communication session. The invention uses a message, herein designated as a media independent handover-handover prepare (MIH_HO_PREPARE) message, to trigger transfer of communication session context information and handover procedures from a first network path comprising a first network of a first type to a second network path comprising a second network of a different type. The MIH_HO_PREPARE message can also be used to trigger Mobile Internet Protocol (MIP) procedures if needed. It should be understood that the name MIH_HO_PREPARE message is not a limitation, but is merely a convenient way to refer to the message which triggers transfer of context information and handover procedures.

In one embodiment, handover of a multi-mode mobile station (MS) is between a wireless system and a wired system, such as between a wireless local area network (WLAN) and a wired local area network (LAN). In this embodiment handover procedures are preferably triggered by a prompt within the MS when making or breaking a wired physical connection.

In other embodiments, handoff is between different wireless systems, for example, between a WLAN and a cellular network. In one such embodiment, handover procedures are triggered by a prompt from within the MS, such as when the signal strength of the active connection falls below a certain threshold. Alternatively, during a communication session the MS can monitor for the availability of one or more different network types, and trigger handover procedures based on the strength of signals from such networks crossing certain thresholds. For example, handover procedures can be triggered by a prompt from within the MS when it detects that a more desirable network type is available. In another embodiment, handover procedures are triggered by a prompt from the active network to the MS, such as when an MS with an active cellular connection enters the service area of a WLAN hot spot. In this embodiment, the cellular network can track the position of the MS, compare it to known locations of WLAN hot spots, and notify the MS when it is within range of a hot spot. To conserve MS battery life, it is advantageous to have the active network notify the MS when an alternative network is available, rather than have the MS monitor for such an alternative network.

In all embodiments, after a handover decision is made, a media independent handover component in the MS generates a MIH_HO_PREPARE message, which prompts the MS to connect to the second network, trigger handover of communication session context information from a network component in the first network path to a network component in the second network path, and re-establish the communication session via the second network path comprising the second network. Context information can include header compression context, Point to Point Protocol (PPP) context, user data, and the like. If mobile IP (MIP) is involved in the handover, the MIH_HO_PREPARE message can also trigger MIP procedures.

### BRIEF DESCRIPTION OF THE DRAWINGS

A more detailed understanding of the invention may be had from the following description, given by way of example and to be understood in conjunction with the accompanying drawings, wherein:

FIGS. 1a, 1b and 1c are schematic illustrations of a handover of a communication session between a mobile station (MS) and a correspondent node (CoN) from via a first path comprising a first network (NW1) to via a second path comprising a second network (NW2), according to the present invention.

FIG. 2 is a flow diagram showing the handover process of FIG. 1, according to the present invention.

FIG. 3 is an illustration of a generic networking scenario in which a communication session between an MS and a CoN proceeds via a first path comprising a first network (NW1) which connects via a first gateway (GW1) to a general network (GN), and thence to the CoN.

FIGS. 4a, 4b and 4c are schematic illustrations of a handover of a communication session from an 802.3 LAN to an 802.X WLAN, according to the present invention.

FIGS. 5a, 5b and 5c are schematic illustrations of a handover from an 802.X WLAN to an 802.3 LAN, according to the present invention.

FIGS. 6a, 6b and 6c are schematic illustrations of a handover from an 802.X WLAN to a 3GPP cellular network, according to the present invention.

FIGS. 7a, 7b, 7c and 7d are schematic illustrations of a handover from a 3GPP cellular network to an 802.X WLAN, according to the present invention.

### DETAILED DESCRIPTION OF THE PREFERRED EMBODIMENTS

The present invention is described with reference to the drawing figures wherein like numerals represent like elements throughout. The term mobile station (MS) as used herein refers to a multi-mode mobile station able to operate via more than one type of network, including but not limited to a user equipment, mobile station, mobile subscriber unit, pager, portable computer or any other type of device capable of operating in a wired or wireless networking environment.

The term network (NW) as used herein refers to any network with which a MS communicates in order to access network services, such as conducting a communication session with a correspondent node (CoN). NWs include but are not limited to wired and wireless networks of all types, such as IEEE 802 family compliant networks of all types such as 802.3, 802.11 and 802.16 compliant networks, and cellular networks of all types such as 3GPP, GSM and GPRS compliant networks.

A method and apparatus are disclosed for transfer of an ongoing communication session between a mobile station (MS) and a correspondent node (CoN) from via a first network path comprising a first network using a first communication standard to via a second network path comprising a second network using a second communication standard. After a handover decision is made, transferring an ongoing communication session requires the MS making a connection with the second network, transferring communication session context information from a network component in the first network path to a network component in the second network path, and continuing the ongoing communication session via the second network path. Handover also typically involves conducting communications during an interim period via network components in both the first and the second network paths, before the communication session is established via the second network path.

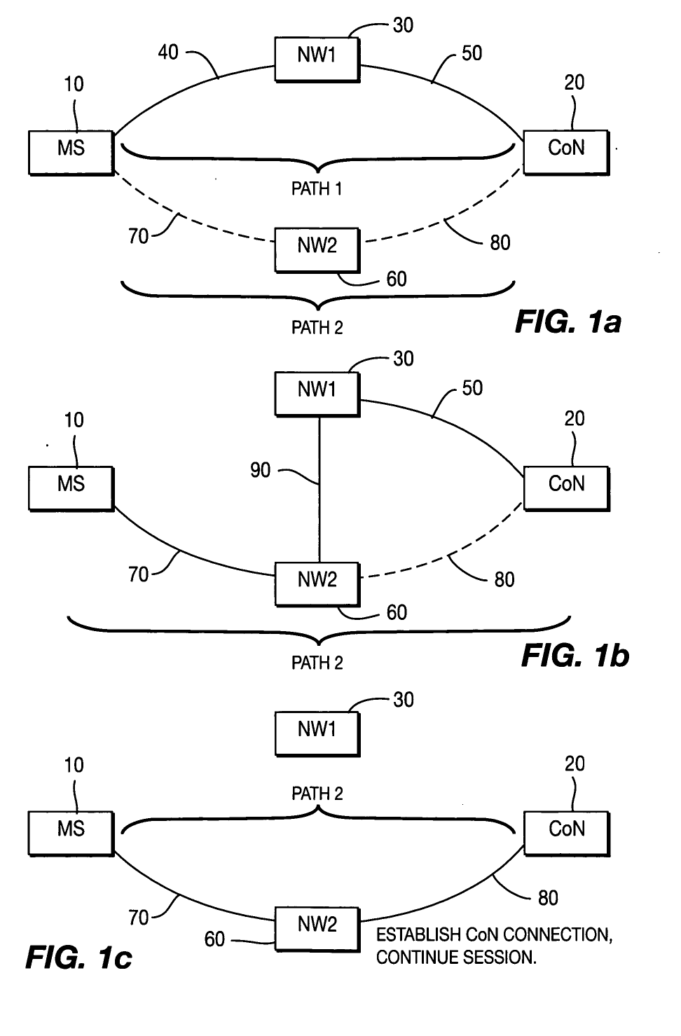

FIGS. 1a, 1b and 1c illustrate the utilization of the invention in a generic multi-mode networking handover scenario. In FIG. 1a, a communication session is being conducted between a mobile station (MS) 10 and a correspondent node (CoN) 20. The communication session is comprised of communication signals sent via a first network (NW1) (30) between the MS 10 and the CoN 20. The MS 10 is communicatively coupled to the first network 30 via communication link 40, and the CoN 20 is communicatively coupled to the first network 30 via communication link 50. Link 40, the first network 30 and link 50 comprise a first signal path (path 1) between the MS 10 and the CoN 20. Also shown in phantom are a second network (NW2) 60 which uses a different communication standard than the first network 30, a potential link 70 between the MS 10 and the second network 60, and a potential link 80 between the CoN 20 and the second network 60. Link 70, the second network 60 and link 80 comprise a second signal path (path 2) between the MS 10 and the CoN 20.

In FIG. 1b a decision has been made to handover the ongoing communication session from via path 1 to via path 2. The handover decision can be made by the MS 10 itself, or a handover decision can be made by another entity and communicated to the MS 10. For example, a device within or in communication with the first network can make a handover decision and communicate it to the MS 10 via link 40.

If the MS 10 makes the handover decision, it may be made because link 40 becomes unavailable. For example, if link 40 is a wired link provided via a network cable and the network cable is unplugged from the MS 10, then the MS 10 could decide to handover the ongoing communication session to path 2. Alternatively, the MS 10 may make the handover decision because a superior link 70 becomes available. For example, if link 40 is a wireless link, and link 70 is a wired link established by plugging a network cable into the MS 10, the MS 10 may decide to handover the communication session to path 2. Alternatively, link 70 can be a wireless link which is superior to link 40, which has become available, such as would happen if the MS 10 moves into the service area of the second network. The MS 10 can become aware of the availability of link 70 by monitoring for the availability of a network such as the second network, or the MS 10 may be notified that it has moved into an area served by the second network, such as by the first network.

Alternatively, a network entity may make the handover decision and communicate it to the MS 10, such as via link 40. Such a decision can be made, for example, in order to better manage network resources.

When the decision is made to handover the communication session to via path 2, a media independent handover component (MIHC) in the MS 10 generates a MIH_HO_PREPARE message, which prompts a mode component in the MS 10 to connect to the second network 60, and prompts the second network 60 to connect to the CoN 20, thus forming path 2. The MIH_HO_PREPARE message also triggers forming a link 90 between the first network 30 and the second network 60, and triggers the transfer of communication session context information from the first network 30 to the second network 60, so that the ongoing communication session can be established and continued via path 2 based on the context information. Context information can include header compression context, Point to Point Protocol (PPP) context, user data, and the like. In addition, while link 80 is being established between the second network 60 and the CoN 20 and path 2 is being prepared to continue the communication session, downlink (DL) signals from the first network 30 to the MS 10 can be forwarded from the first network 30 to the MS 10 via link 90, the second network 60 and link 70. Alternatively, DL signals may be stored at the first network 30 and a copy forwarded to the MS 10 via link 90, the second network 60 and link 70. DL signals can be sent in this manner from the first network to the MS 10 until the ongoing communication session is established via path 2, or alternatively for a preferred length of time. Optionally, uplink (UL) signals can also be sent from the MS 10 to the first network 30 via link 70, the second network 60 and link 90, and thence to the CoN 20, until the ongoing communication session is established via path 2.

In FIG. 1c, path 2 comprising link 70, the second network 60 and link 80 has been established, and the communication session context information, transferred from the first network 30 to the second network 60, has been used to continue the ongoing communication session between the MS 10 and the CoN 20 via path 2.

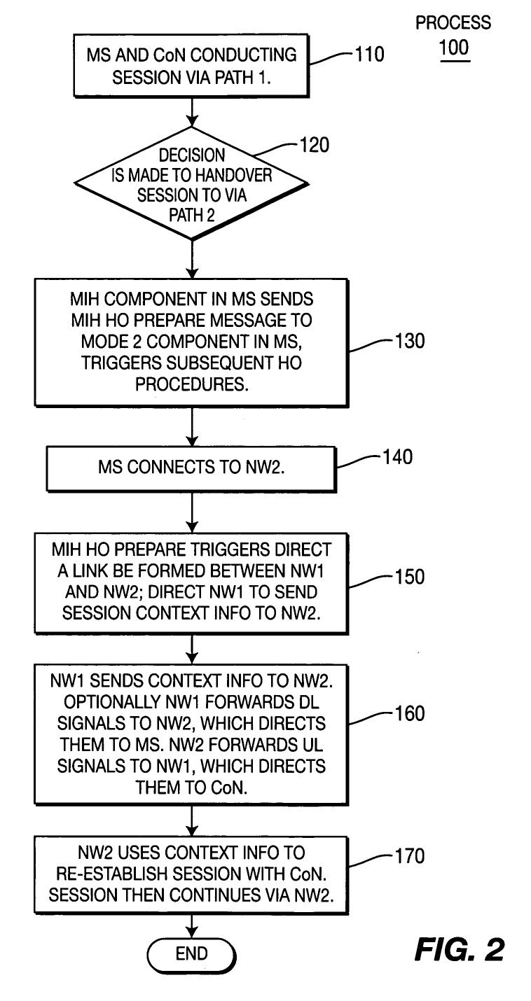

FIG. 2 is a block diagram summarizing handover process 100. Initially, the MS 10 and the CoN 20 are conducting a communication session via path 1, step 110. A decision is made to handover the communication session to via path 2, step 120. A media independent handover (MIH) component in the MS 10 sends an MIH_HO_PREPARE message to a mode component in the MS 10 which can communicate with the second network 60, step 130. The MIH_HO_PREPARE message also triggers the subsequent procedures by which the ongoing communication session is handed over to path 2 and the session is continued. The MS 10 connects to the second network 60, step 140, and establishes link 80 between the second network 60 and the CoN 20, thereby forming path 2. Procedures triggered by the MIH_HO_PREPARE message direct that a link 90 be formed between the first network 30 and the second network 60, and direct the first network 30 to send session context information to the second network 60, step 150. The first network 30 sends the context information to the second network 60; and optionally the first network 30 causes DL signals to be sent to the second network, which directs them to the MS 10, step 160. UL signals can also optionally be sent by the second network 60 to the first network 30, which directs them to the CoN 20 until the ongoing communication session is handed over to via path 2. The second network uses the context information to establish the ongoing communication session between the MS 10 and the CoN 20 to via path 2, step 170. The session then continues via path 2.

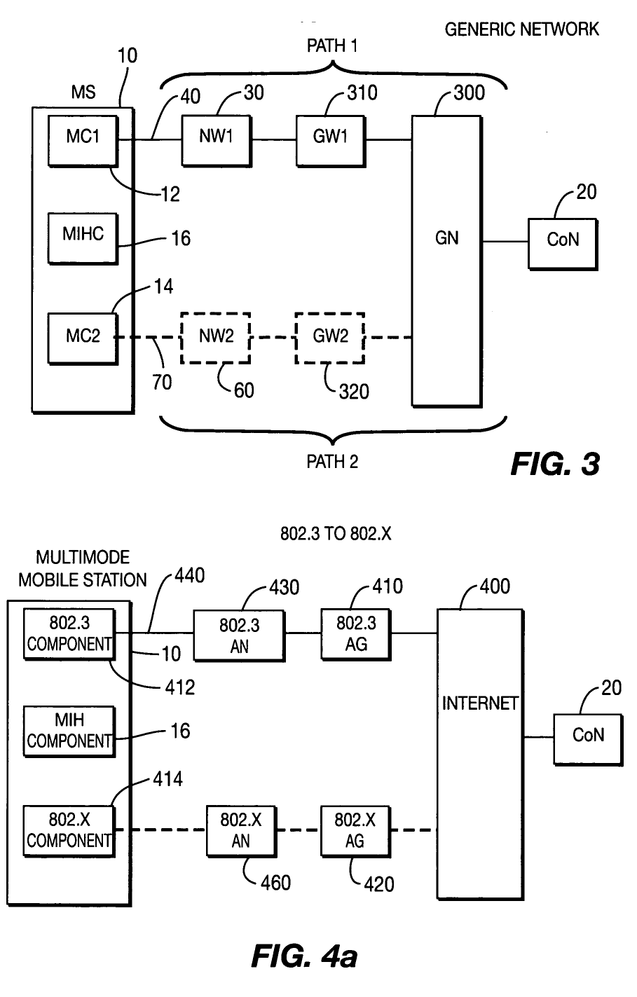

FIG. 3 illustrates implementation of the invention wherein a general network (GN) 300, such as the Internet or a cellular core network, exists between the first network 30 and the CoN 20, and also between the second network 60 and the CoN 20. The first network 30 can connect to the GN 300 via a first gateway (GW1) 310, and the second network 60 can connect to the GN 300 via a second gateway (GW2) 320. Also shown are a first mode component (MC1) 12 within the MS 10 able to communicate with the first network 30 via link 40, and a second mode component (MC2) 14 able to communication with the second network 60 via link 70. Also shown in the MS 10 is a media independent handover component (MIHC) 16, which generates an MIH_HO_PREPARE message.

In FIG. 3, the first mode component 12 is initially communicatively coupled with the first network 30, whereby the MS 10 is conducting a communication session with the CoN 20 via a path 1 which includes the first network 30, the first gateway 310 and the general network 300. A decision is made to handover the communication session to a path 2 that includes the second network 60, the second gateway 320 and the general network 300. The handover is initiated by the MIHC 16 sending an MIH_HO_PREPARE message to the second mode component 14, whereupon the second mode component 14 establishes a connection with the second network 60, and triggers establishing path 2. The MIH_HO_PREPARE message also triggers the transfer of context information from at least one network component in path 1 to at least one network component in path 2; optionally triggers sending DL signals from at least one network component in path 1 to at least one network component in path 2 to be forwarded to the MS 10; optionally triggers sending UL signals from at least one network component in path 2 to at least one network component in path 1 to be forwarded to the CoN 20; and triggers continuing the ongoing communication session between the MS 10 and the CoN 20 via path 2 using the transferred context information. In actual implementations, one or more of the first network, the first gateway, the second network, the second gateway and the general network can comprise multiple network components. The network components in path 1 and path 2 that are involved in transferring context information and sending DL and UL signals will depend on the specifics of each implementation. Exemplary implementations are described hereinafter.

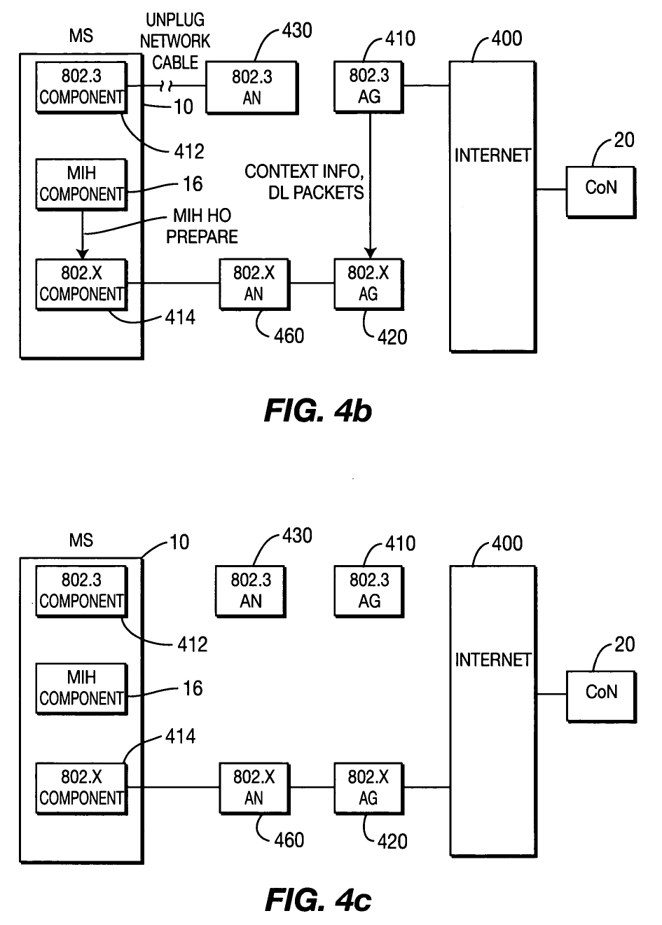

FIGS. 4a, 4b and 4c show an exemplary implementation in which an ongoing communication session between the MS 10 and the CoN 20 is handed over from a path 1 including a wired connection between the MS 10 and an 802.3 network, to a path 2 including a wireless connection between the MS 10 and an 802.X wireless network, according to the present invention. In FIG. 4a, an 802.3 mode component 412 in the MS 10 is initially communicatively coupled to an 802.3 access network (AN) 430 via a network cable 440, whereby the MS 10 is conducting a communication session with the CoN 20 via a path 1 which includes an 802.3 access network (AN) 430, an 802.3 access gateway (AG) 410 including an 802.3 access router (AR) (not shown) and Internet 400. Alternative path 2 (shown in phantom) comprises an 802.X access network 460, an 802.X access gateway 420 including an 802.X access router (not shown) and Internet 400.

In FIG. 4b, a decision is made to handover the communication session to via a path 2. The handover can be initiated, for example, by unplugging network cable 440 from the MS 10 while the MS 10 is located in the service area of the 802.X access network 460. The handover is initiated by the MIHC 16 sending an MIH_HO_PREPARE message to the 802.X mode component 414 in the MS 10, whereupon the 802.X mode component 414 establishes a connection with the 802.X access network 460, and associates and authenticates in the 802.X access gateway 420.

The MS 10 obtains the IP address of the 802.X access gateway 420. The MS 10 then triggers the context transfer procedure and the data forwarding procedure from the 802.3 access gateway 410 to the 802.X access gateway 420. If mobile IP (MIP) is being used, while context is being transferred to the 802.X access gateway 420, data is forwarded from the 802.3 access gateway 410 to the 802.X access gateway 420 to the MS 10. This allows the MS 10 to receive user data before a new care of address (CoA) is negotiated with the 802.X access router. The MS 10 negotiates a new CoA using prior art MIP messages. When the new CoA is ready and a connection is established, the user data path can be switched from CoN 20 to the 802.X access gateway 420. The old CoA can then be de-registered. If layer 3 soft handover (L3SH) is used, context can be activated after a new connection from the 802.X access router to the CoN 20 has been established. FIG. 4c shows the ongoing communication session between the MS 10 and the CoN 20 after it has been handed over to via path 2.

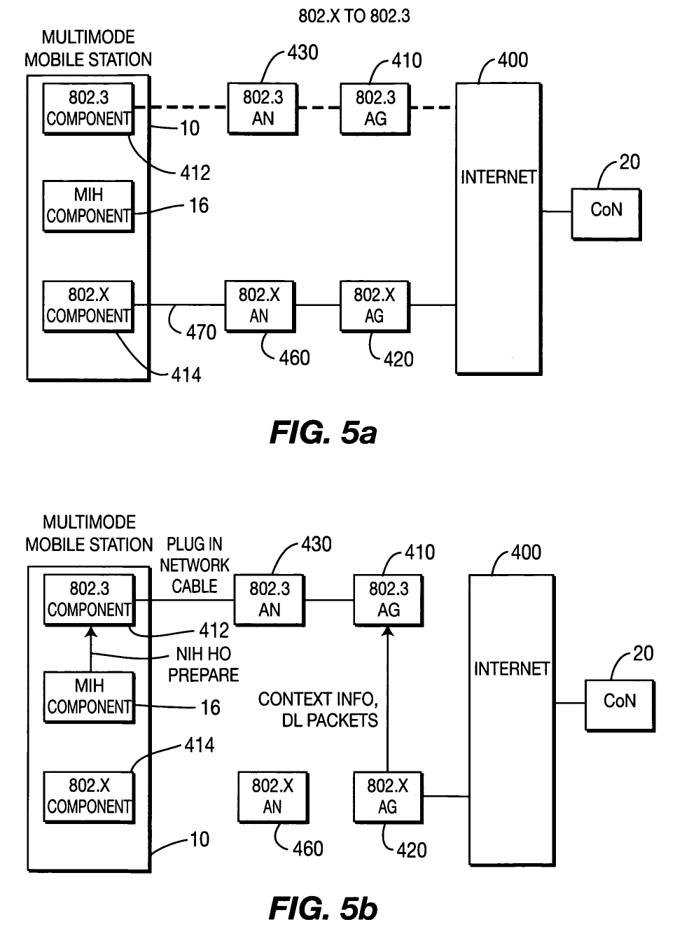

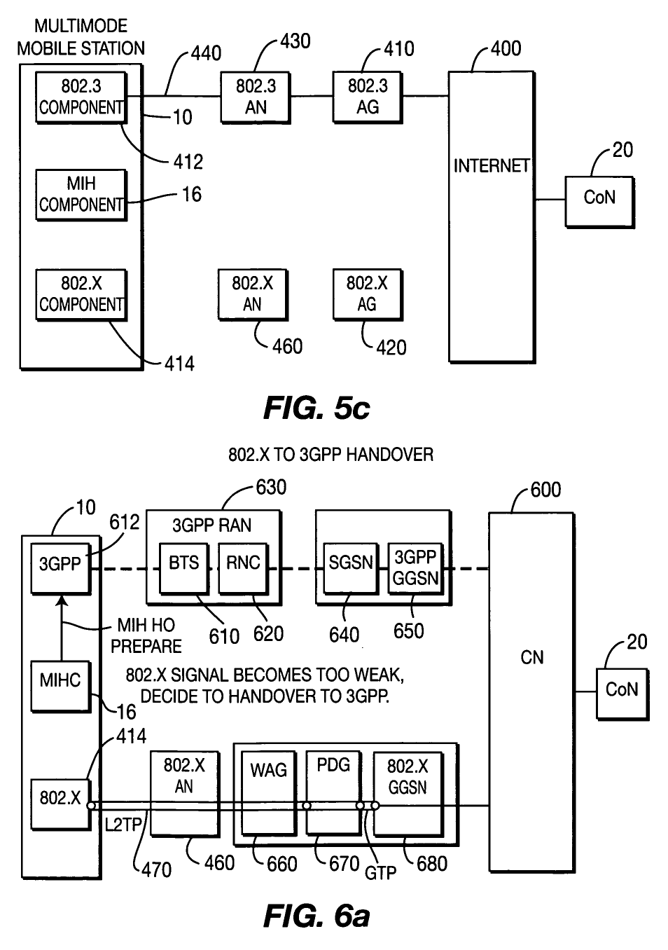

FIGS. 5a, 5b and 5c show an exemplary implementation in which an ongoing communication session between the MS 10 and the CoN 20 is handed over from a path 1 including a wireless connection 470 between the MS 10 and a 802.X access network (AN) 460, to a path 2 including a wired connection between the MS 10 and the 802.3 access network 430, according to the present invention. In FIG. 5a, an 802.X mode component 414 in the MS 10 is initially connected to the 802.X access network 460 via air interface 470, whereby the MS 10 is conducting a communication session with the CoN 20 via a path 1 which includes the 802.X access network 460, the 802.X access gateway (AG) 420 including an 802.X access router (AR) (not shown) and Internet 400. Path 2, shown in phantom, comprises an 802.3 access network (AN) 430, 802.3 access gateway (AG) 410 including an 802.3 access router (AR) (not shown) and Internet 400.

In FIG. 5b, a decision is made to handover the communication session to via the path 2. The handover can be initiated, for example, by plugging network cable 440 into the MS 10. The handover is initiated by MIHC 16 sending an MIH_HO_PREPARE message to the 802.3 mode component 412 in the MS 10, whereupon the 802.3 mode component 412 establishes a connection with the 802.3 access network 430, and associates and authenticates in the 802.3 access gateway 410.

The MS 10 obtains the IP address of the 802.3 access gateway 410. The MS 10 then triggers the context transfer procedure and the data forwarding procedure from the 802.X access gateway 420 to 802.3 access gateway 410. If mobile IP is being used, while context is being transferred to the 802.3 access gateway 410, data can be forwarded from the 802.X access gateway 420 to the 802.3 access gateway 410 to the MS 10. This allows the MS 10 to receive user data before a new care of address (CoA) is negotiated with the 802.3 access router. The MS 10 negotiates a new CoA using prior art MIP messages. When the new CoA is ready and a connection is established, the user data path can be switched from the CoN 20 to the 802.3 access gateway 410. The old CoA can then be de-registered. If layer 3 soft handover (L3SH) is used, context can be activated after a new connection from the 802.3 access router to the CoN 20 has been established. FIG. 5c shows the ongoing communication session between the MS 10 and CoN 20 after it has been handed over to via path 2.

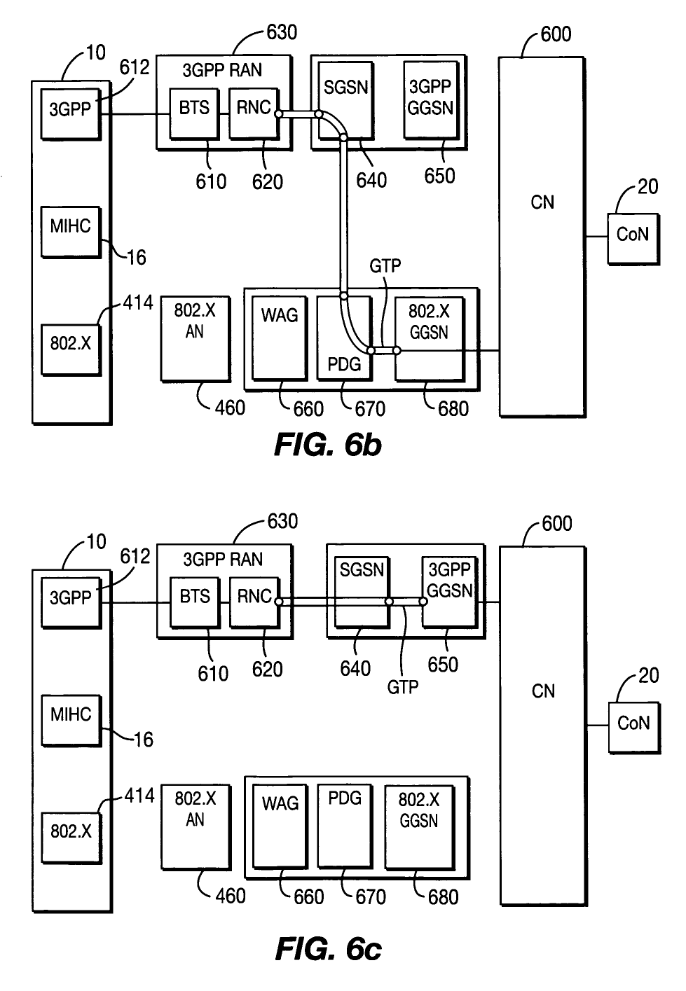

FIGS. 6a, 6b and 6c show an exemplary implementation in which an ongoing communication session between the MS 10 and the CoN 20 is handed over from via a path 1 including a wireless connection 470 between the MS 10 and the 802.X access network 460, to via path 2 (shown in phantom) including a wireless connection between the MS 10 and 3GPP base transceiver station (BTS) 610, according to the present invention. In FIG. 6a, the 802.X mode component 414 in the MS 10 is initially communicatively coupled to the 802.X access network (AN) 460 via air interface 470, whereby the MS 10 is conducting a communication session with the CoN 20 via a path 1 which includes the 802.X access network 460, wireless access gateway (WAG) 660, packet data gateway (PDG) 670, 802.X gateway GPRS support node (GGSN) 680 and cellular core network (CN) 600. Path 2, shown in phantom, comprises the BTS 610, radio network controller (RNC) 630, serving GPRS support node (SGSN) 640, the 3GPP GGSN 650, and the CN 600. A decision is made to handover the communication session from via path 1 to via a path 2. The handover can be initiated, for example, by the MS moving out of the service area of the 802.X access network 460. The handover is initiated by the MIHC 16 sending an MIH_HO_PREPARE message to the 3GPP mode component 612 in the MS 10.

In FIG. 6b, the MS 10 initiates cell selection and performs routing area update, whereby the 3GPP component 612 establishes communicative coupling with the BTS 610, the RNC 620 and the SGSN 640. The MS 10 prompts the SGSN 640 to request the transfer of communication session context information from the PDG 670 to the SGSN 640. The PDG 670 sends context information for both UL and DL flows to SGSN 640, including packet data protocol (PDP) context. The PDG 670 then stops sending DL packets toward the MS 10. The PDG 670 buffers DL packets, establishes a gateway tunneling protocol (GTP) tunnel to the SGSN 640, and sends a duplicate of every packet that is buffering towards the SGSN 640. This is done for a preferred period of time, or until the SGSN 640 is ready to process DL packets from the 3GPP GGSN 650.

In FIG. 6c, the PDP context is updated at the 3GPP GGSN 650, and a new GTP tunnel is established between the 3GPP GGSN 650 and the SGSN 640. The communication session is thereby successfully activated in path 2, and the ongoing communication session continues between the MS 10 and the CoN 20. The 802.X radio connection can then be released.

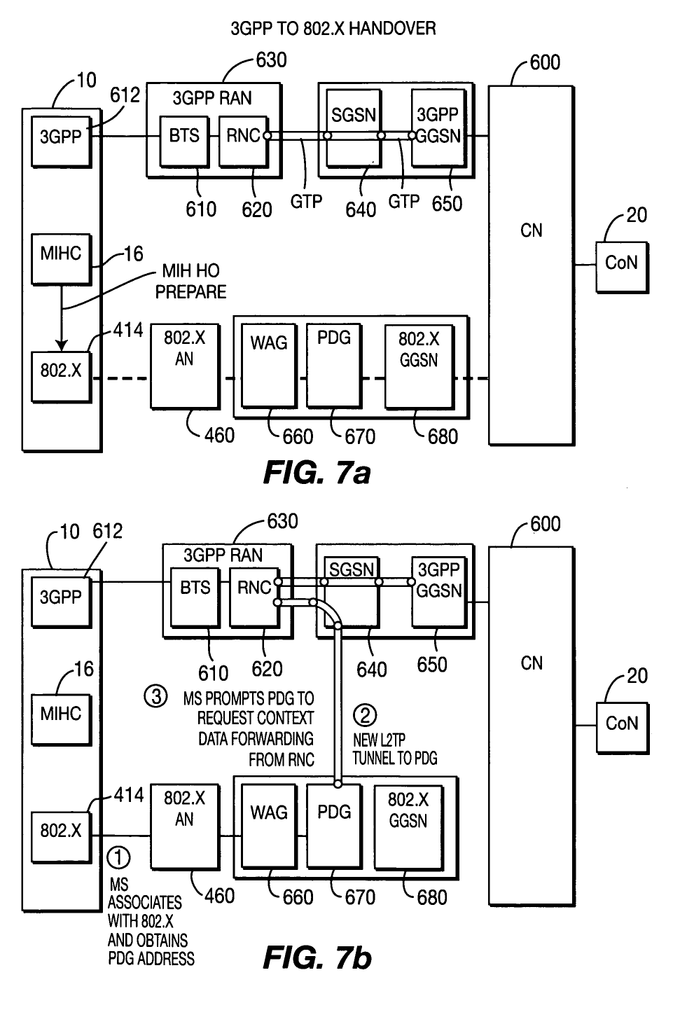

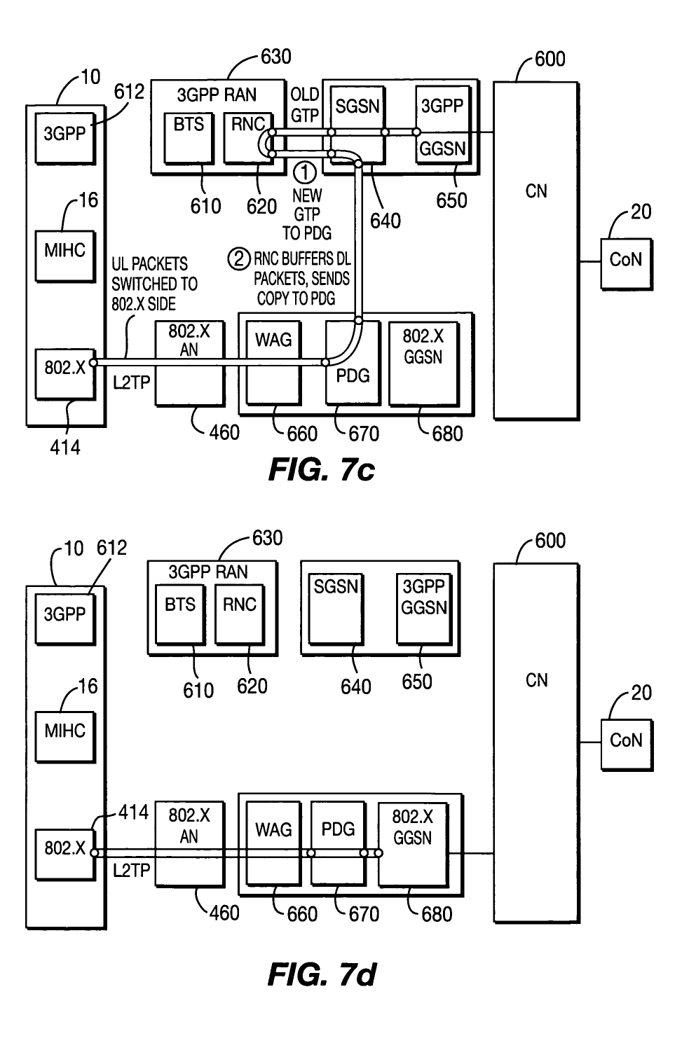

FIGS. 7a, 7b, 7c and 7d show an exemplary implementation in which an ongoing communication session between the MS 10 and the CoN 20 is handed over from via a path 1 including a wireless connection between the MS 10 and the 3GPP BTS 610, to via a path 2 (shown in phantom) including a wireless connection between the MS 10 and the 802.X access network 460, according to the present invention. In FIG. 7a, the 3GPP component 612 in the MS 10 is initially communicatively coupled to the BTS 610 via an air interface, whereby the MS 10 is conducting a communication session with the CoN 20 via a path 1 which includes the BTS 610, radio network controller (RNC) 630, serving GPRS support node (SGSN) 640, 3GPP GGSN 650, and the CN 600. Path 2, shown in phantom, comprises the 802.X access network 460, the WAG 660, the PDG 670, the 802.X GGSN 680 and the CN 600. A decision is made to handover the communication session from via path 1 to via a path 2. The handover can be initiated, for example, by the MS moving into the service area of the 802.X AN 460, being notified by BTS 610 that an 802.X network is available, and the 802.X component 414 scanning for the 802.X network. Alternatively, the 802.X component 414 can execute periodic scanning, either continuously or when prompted by system information received from the 3GPP mode component 612. The handover is initiated by the MIHC 16 sending an MIH_HO_PREPARE message to the 3GPP component 612.

In FIG. 7b, the MS 10 executes the 802.X system association and authentication towards 802.X access network 460, whereby the 802.X component 414 establishes communicative coupling with the 802.X access network 460, the WAG 660, the PDG 670, the 802.X GGSN 680 and the CN 600. The MS 10 uses the WLAN identity and associated public land mobile network (PLMN) to construct a fully qualified domain name (FQDN) and uses it to obtain the associated address of the PDG 670 through domain naming system (DNS) query. The MS 10 uses this address to establish a tunnel from 3GPP component toward the PDG 670 via the BTS 610, the RNC 620 and the SGSN 640, for example, using layer 2 tunneling protocol (L2TP). When the tunnel is established, the MS 10 executes routing area update towards the PDG 670. The routing data update received at the PDG 670 triggers a context transfer request from the PDG 670 towards the SGSN 640. Context information, including PDP context information, is taken from the RNC 620 and sent to the PDG 670 via the SGSN 640. Both UL and DL context information is sent. After the PDP context is transferred, the RNC 620 stops sending DL packets towards the MS 10. The RNC 620 buffers DL packets.

In FIG. 7c, when the PDG 670 is ready to start processing packets, the RNC 620 establishes a new GTP tunnel toward the PDG 670, and sends a duplicate of the buffered packets toward the PDG 670 via the SGSN 640. The PDG 670 forwards the DL packets to the 802.X mode component 414. This is done for a preferred period of time.

In FIG. 7d, the PDP context is updated at the 802.X GGSN 680, and a new GTP tunnel is established between the PDG 670 and the GGSN 680. Packets can then be sent directly from the 802.X GGSN 680 to the PDG 670. The communication session is thereby successfully activated in path 2, and the ongoing communication session continues between the MS 10 and the CoN 20. The 3GPP radio connection can then be released.

Other scenarios are possible, and are within the scope of the invention, such as handover between an IEEE 802.3 wired network and a cellular network. Although the features and elements of the present invention are described in the preferred embodiments in particular combinations, each feature or element can be used alone (without the other features and elements of the preferred embodiments) or in various combinations, with or without other features and elements of the present invention.

What is claimed is:

1. A multi-mode mobile station (MS) having a plurality of mode components, each mode component configured to communicate using a different communication standard, the MS configured to handover an ongoing communication session with a correspondent node (CoN) for which communication session context information is defined from a first network path comprising a plurality of network components using a first communication standard to a second network path comprising a plurality of network components using a second communication standard, comprising:
a first mode component configured to communicate via the first communication standard;
a second mode component configured to communicate via the second communication standard;
a media independent handover component (MIHC) configured to send a message to said second mode component, to initiate procedures to establish the second network path and transfer the communication session context information from a network component in the first network path to a network component in the second network path, whereby the ongoing communication session is handed off from via the first mode component and first network path to via the second mode component and second network path.

2. The MS of claim 1, wherein the message also triggers mobile IP (MIP) procedures.

3. The MS of claim 1, wherein signals sent by a network component to the MS are downlink (DL) signals, and the message triggers the storing of downlink (DL) signals in a network component in the first path.

4. The MS of claim 1, wherein signals sent by a network component to the MS are downlink (DL) signals, and the message triggers the sending of DL signals from a network component in the first path to a network component in the second path.

5. The MS of claim 4, wherein the DL signals are sent from the network component in the first path to the network component in the second path for a preferred period of time

6. The MS of claim 4, wherein the DL signals are sent from the network component in the first path to the network component in the second path until the communication session is established via the second path, whereupon the communication signals are sent only via the second path.

7. The MS of claim 1, wherein the first mode component communicates with one of an IEEE 802.3 compliant network, an IEEE 802.11 family compliant network, an IEEE 802.16 compliant network, a GSM network, a GPRS network, a 3GPP-based W-CDMA FDD network, a 3GPP-based TDD network, a 3GPP-based TD-SCDMA network, a 3GPP2-based CDMA2000 network, a 3GPP2-based 1× network, a 3GPP2-based EV-DO network, or a 3GPP2-based EV-DV network; and the second mode component communicates with a different one of an IEEE 802.3 compliant network, an IEEE 802.11 family compliant network, an IEEE 802.16 compliant network, a GSM network, a GPRS network, a 3GPP-based W-CDMA FDD network, a 3GPP-based TDD network, a 3GPP-based TD-SCDMA network, a 3GPP2-based CDMA2000 network, a 3GPP2-based 1× network, a 3GPP2-based EV-DO network, or a 3GPP2-based EV-DV network.

8. A method for handing over a communication session between a mobile station (MS) and a correspondent node (CoN), wherein the communication session is comprised of communication signals sent via a signal path comprising a plurality of network components between the MS and the CoN, wherein the signals received by the MS from the network are downlink (DL) signals and the signals sent by the MS to the network are uplink (UL) signals, wherein parameters describing the communication session comprise communication session context information;
the MS comprising at least a first mode component capable of communicatively coupling with a first network using a first communication standard, whereby communication signals can be sent between the MS and the CoN via a first network path (path 1) comprising a plurality of network components; and a second mode component capable of communicatively coupling with a second network using a second communication standard, whereby communication signals can be sent between the MS and the CoN via a second network path (path 2) comprising a plurality of network components;
the MS further comprising a media independent handover component (MIHC) which initiates procedures facilitating handover of a communication session from via path 1 to via path 2,
the method comprising:
establishing a communication session between the MS and the CoN via path 1;
deciding to handover the communication session from via path 1 to via path 2, and communicating the decision to the MIHC;
generating and sending a message to the second mode component to initiate handover procedures;
establishing a connection between the second mode component and the second network;
contacting a network component in path 1 with access to communication session context information, and directing the network component in path 1 to acquire and send to a network component in path 2 the communication session context information;
sending the communication session context information to the network component in path 2;
switching sending uplink (UL) signals from using the first mode component to using the second mode component;
establishing the communication session between the MS and the CoN via path 2; and
continuing the communication session between the MS and the CoN via path 2.

9. The method of claim 8, further comprising:
directing the network component in path 1 to send to the network component in path 2 downlink (DL) signals directed to the MS;
sending said DL signals to the network component in path 2;
forwarding said DL signals to the MS; and
using the context information to continue the communication session between the MS and the CoN via the network component in path 1 and the network component in path 2.

10. The method of claim 8, further comprising:
breaking the connection between the MS and the first network before deciding to handover the communication session from via path 1 to via path 2.

11. The method of claim 8, further comprising:
experiencing a reduction in a value related to a signal strength of the connection between the first mode component and the first network, such that the value drops below a threshold value, before deciding to handover the communication session from via path 1 to via path 2.

12. The method of claim 8, wherein the contacting a network component in path 1 step is accomplished by the MS contacting the network component in path 1 using the second mode component via the second network.

13. The method of claim 8, wherein the contacting a network component in path 1 step is accomplished by the MS contacting the first network via the first mode component.

14. The method of claim 8 wherein the switching sending uplink (UL) signals step occurs after the establishing communication between the MS and the CoN via the path 2 step, and UL packets are sent to the CoN via path 2.

15. The method of claim 8 wherein the switching sending uplink (UL) signals step occurs before the establishing communication between the MS and the CoN via path 2 step, and the UL signals are sent via a network path comprising the second network, the network component in path 2, and the network component in path 1, to the CoN, until the communication session between the MS and the CoN via path 2 is established, thereafter the UL signals are sent via path 2 to the CoN.

16. The method of claim 8 wherein the generating and sending a message to the second mode component step also triggers mobile IP (MIP) procedures.

17. The method of claim 8 wherein the first network is one of an IEEE 802.3 compliant network, an IEEE 802.11 family compliant network, an IEEE 802.16 compliant network, a GSM network, a GPRS network, a 3GPP-based W-CDMA FDD network, a 3GPP-based TDD network, a 3GPP-based TD-SCDMA network, a 3GPP2-based CDMA2000 network, a 3GPP2-based 1× network, a 3GPP2-based EV-DO network, or a 3GPP2-based EV-DV network; and the second network is a different one of an IEEE 802.3 compliant network, an IEEE 802.11 family compliant network, an IEEE 802.16 compliant network, a GSM network, a GPRS network, a 3GPP-based W-CDMA FDD network, a 3GPP-based TDD network, a 3GPP-based TD-SCDMA network, a 3GPP2-based CDMA2000 network, a 3GPP2-based 1× network, a 3GPP2-based EV-DO network, or a 3GPP2-based EV-DV network.
